(19) United States
(12) Patent Application Publication
(10) Pub. No.: US 2019/0182644 A1
(43) Pub. Date: Jun. 13, 2019

(54) RESOURCE SCHEDULING METHOD AND DEVICE FOR VEHICLE COMMUNICATION, TERMINAL AND BASE STATION

(71) Applicant: YULONG COMPUTER TELECOMMUNICATION SCIENTIFIC (SHENZHEN) CO., LTD., Shenzhen (CN)

(72) Inventors: QIAN ZHENG, Shenzhen (CN); YI-XUE LEI, Shenzhen (CN); YUN-FEI ZHANG, Shenzhen (CN)

(73) Assignee: YULONG COMPUTER TELECOMMUNICATION SCIENTIFIC (SHENZHEN) CO., LTD., Shenzhen (CN)

(21) Appl. No.: 16/321,938

(22) PCT Filed: Oct. 29, 2016
(86) PCT No.: PCT/CN2016/103868

§ 371 Date: Jan. 30, 2019

(30) Foreign Application Priority Data
Aug. 5, 2016 (CN) 201610639482.4

(51) Int. Cl. H04W 4/46; H04W 72/12; H04W 72/04; H04W 76/11; H04W 76/27

(52) U.S. Cl. CPC H04W 4/46; H04W 72/1205; H04W 72/042; H04W 76/11; H04W 76/27; H04W 72/0446

(57) ABSTRACT

An embodiment of the disclosure provides a resource scheduling method for a vehicle communication, a device, a terminal and a base station, the method includes: receiving a plurality of groups of configuration parameters for semi-persistent scheduling allocated by a base station. A message feature after the current vehicle communication service is changed, and/or a message feature of a new vehicle communication service to the base station is sent, when the message feature of the current vehicle communication service is detected to be changed, and/or it is detected that the new vehicle communication message needs to be processed, indication information from the base station, and the indication information being used for indicating a semi-persistent scheduling process needs to be activated to the vehicle communication terminal is received; and the semi-persistent scheduling process needs to be activated is activated.

### CROSS-REFERENCE TO RELATED APPLICATIONS

This application claims priority of Chinese Patent Application No. 201610639482.4, entitled “resource scheduling method and device for vehicle communication, terminal and base station” filed on Aug. 5, 2016 in the China National Intellectual Property Administration (CNIPA), the entire contents of which are incorporated by reference herein.

### FIELD

The present disclosure relates to a technical field of communication, specifically a resource scheduling method for vehicle communication, a resource scheduling device for a vehicle communication, a terminal and a base station.

### BACKGROUND

Vehicle to Vehicle (V2V, a communication from a vehicle to a vehicle) is an Internet of vehicles project approved by 3rd Generation Partnership Project (3GPP) RAN#71, which mainly researches solutions for V2V communication based on the 3rd Generation Partnership Project (3GPP) Device to Device (D2D, terminal indirect communication) communication protocol.

A vehicle terminal (such as Vehicle UE, hereinafter collectively referred to as V-UE) continuously sends a V2V message to surrounding vehicle terminals during moving, and the V2V message may be periodic or non-periodic. A definition of the periodic V2V message includes the following three types: a Cooperative Awareness Message (CAM), a Decentralized Environmental Notification Message (DENM), and a Basic Safety Message (BSM). Among them, the V2V message feature of the DEMN type and the BSM type are variable in size but fixed in period, the size and the period of the V2V message feature of the CAM type are variable.

At present, a resource allocation of D2D communication mainly includes two manners, namely, a scheduling manner and a resource pool manner. In the scheduling manner, the resources of the D2D communication are allocated by a base station. For the periodic V2V message, a related art proposes that the base station can adopt a semi-persistent resource allocation mechanism through a D2D secondary link, that is, secondary link (SL) Semi-Persistent Scheduling (SPS). Communication resources are periodically allocated to certain V-UEs, so that signaling overhead is saved.

In a current LTE system, for each V-UE, in order to support the V2V messages that are variable in message size and period, a plurality of SL SPS configurations are needed, and each SL SPS configuration can correspond to different message sizes, periods, and the like. However, whether the plurality of SL SPS configurations can be activated at the same time, and how reporting information of the V-UE for assisting the SL SPS configuration are an urgent technical problem to be solved.

### SUMMARY

The at least one of the above technical problems to be solved by embodiments of the present disclosure is to provide a new resource scheduling solution for vehicle communication, thus reported information of terminals can assist the base station to determine a semi-persistent scheduling process that needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

In order to solve the above technical problems, according to a first embodiment of the present disclosure, a resource scheduling method for a vehicle communication is provided and executable on a vehicle communication terminal, the method includes: receiving a plurality of groups of configuration parameters for semi-persistent scheduling allocated by a base station, each of the plurality of groups of the configuration parameters corresponding to one semi-persistent scheduling process; detecting whether a message feature of a current vehicle communication service is changed, and/or whether a new vehicle communication service needs to be processed; sending a message feature after the current vehicle communication service is changed, and/or a message feature of a new vehicle communication service to the base station, when the message feature of the current vehicle communication service is detected to be changed, and/or it is detected that the new vehicle communication message needs to be processed; receiving indication information from the base station according to the changed message feature and/or the message feature of the new vehicle communication service, and the indication information being used for indicating a semi-persistent scheduling process needs to be activated to the vehicle communication terminal; and activating the semi-persistent scheduling process needs to be activated based on configuration parameters corresponding to the semi-persistent scheduling process needs to be activated.

In the above embodiment, since one semi-persistent scheduling process corresponds to one group of configuration parameter, and different configuration parameters are applicable to vehicle communication services with corresponding message features, that is different semi-persistent scheduling processes correspond to message features of the vehicle communication services, therefore, the vehicle communication terminal can detect whether the message feature of the current vehicle communication service is changed, and whether the new vehicle communication service needs to be processed, and report a detection result to the base station to assist the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

Regarding how to receive the plurality of groups of configuration parameters for semi-persistent scheduling allocated by the base station, the present disclosure provides following two manners:

A First Manner:

Receiving a Radio Network Temporary Identity (RNTI), an effective duration of the semi-persistent scheduling, and a period of the semi-persistent scheduling corresponding to each of the plurality of groups of the configuration parameters of the plurality configuration parameters sent by the base station through a Radio Resource Control (RRC) signaling.

In the first manner, different configuration parameters correspond to different RNTIs, that is, different semi-persistent scheduling processes can be distinguished by the RNTI. Specifically, the vehicle communication terminal can demodulate the time-frequency resources corresponding to different semi-persistent scheduling processes based on the RNTI.

A Second Manner:

Receiving the RNTI for the semi-persistent scheduling sent by the base station through the RRC signaling, and receiving the identification information, the effective duration of the semi-persistent scheduling, and the period of the semi-persistent scheduling corresponding to each of the plurality of groups of the configuration parameters of the plurality configuration parameters sent by the base station through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal can demodulate the time-frequency resources corresponding to different semi-persistent scheduling processes based on the identification information in the RNTI and the DCI signaling.

In any one of the above embodiments, optionally, the resource scheduling method for the vehicle communication further includes: when it is determined that any one of semi-persistent scheduling process needs to be activated, sending a notification message to activate the any one of semi-persistent scheduling process to the base station.

In the above embodiment, by determining that any one of semi-persistent scheduling process needs to be activated, sending a notification message to activate the semi-persistent scheduling process to the base station, thus the base station can release the time-frequency resources corresponding to the semi-persistent scheduling process in time, waste of resources can be avoided. When the vehicle communication terminal determines that it is not necessary to process a certain vehicle communication service, it is determined that the semi-persistent scheduling process corresponding to the vehicle communication service needs to be activated. In addition, when the effective duration of the semi-persistent scheduling process expires, the vehicle communication terminal determines that it is also necessary to activate the semi-persistent scheduling process scheduling process that needs to be activated, but in this case, it is not necessary to send the notification message to the base station, because the base station can voluntarily determine according to the configuration parameters corresponding to the semi-persistent scheduling process.

In any one of the above embodiments, optionally, the message feature after the current vehicle communication service is changed and/or the message feature of the new vehicle communication service, can be sent to the base station through a medium access control unit signaling or the RRC signaling.

In any one of the above embodiments, optionally, the message feature includes at least one or a combination of the following: a message period, a message size, a transmission time offset, a priority of a vehicle communication service, a modulation coding manner adopted by the vehicle communication message.

The transmission time offset can be used to determine a time point when the vehicle communication message is sent in the next cycle. Specifically, the transmission time offset can be represented by a sub-frame number.

According to a second embodiment of the present disclosure, another resource scheduling method for a vehicle communication is provided and executable on a base station, the method includes: sending a plurality of groups of configuration parameters for semi-persistent scheduling to a vehicle communication terminal, each of the plurality of groups of the configuration parameters corresponding to one semi-persistent scheduling process; receiving a message feature after a current vehicle communication service is changed sent by the vehicle communication terminal, and/or a message feature of a new vehicle communication service needs to be processed; determining the semi-persistent scheduling process that needs to be activated according to the changed message feature and/or the message feature of the new vehicle communication service; sending indication information to the vehicle communication terminal, to enable the vehicle communication terminal to activate the semi-persistent scheduling process that needs to be activated.

In the above embodiment, by sending a plurality of groups of configuration parameters for semi-persistent scheduling to the vehicle communication terminal, the vehicle communication terminal can activate the corresponding semi-persistent scheduling process based on the configuration parameters for the semi-persistent scheduling when receiving the indication information from the base station. Meanwhile, since one semi-persistent scheduling process corresponds to one group of the configuration parameter, and different configuration parameters are applicable to vehicle communication services with corresponding message features, that is different semi-persistent scheduling processes correspond to message features of the vehicle communication services. Therefore, by receiving the reported information sent by the vehicle communication terminal, that is, the changed message feature of the current vehicle communication service and/or the message feature of the new vehicle communication service, so that the reported information of the vehicle communication terminal can assist the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

Regarding how to send the plurality of groups of configuration parameters for semi-persistent scheduling to the vehicle communication terminal, the present disclosure provides following two manners:

A First Manner:

Sending a Radio Network Temporary Identity (RNTI), an effective duration of the semi-persistent scheduling, and a period of the semi-persistent scheduling corresponding to each of the plurality of groups of the configuration parameters of the plurality configuration parameters to the vehicle communication terminal through a Radio Resource Control (RRC) signaling.

In the first manner, different configuration parameters correspond to different RNTIs, that is, different semi-persistent scheduling processes can be distinguished by the RNTI. The vehicle communication terminal can demodulate the time-frequency resources corresponding to different semi-persistent scheduling processes based on the RNTI.

A Second Manner:

Sending the RNTI for the semi-persistent scheduling to the vehicle communication terminal through the RRC signaling, and sending the identification information, the effective duration of the semi-persistent scheduling, and the period of the semi-persistent scheduling corresponding to each of the plurality of groups of the configuration parameters of the plurality configuration parameters to the vehicle communication terminal through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal may demodulate time-frequency resources corresponding to different semi-persistent scheduling processes based on the identification information in the RNTI and the DCI signaling.

In any one of the above embodiments, optionally, the resource scheduling method for the vehicle communication further includes: activating any one of the semi-persistent scheduling process, when receiving a notification message to activate the any one of semi-persistent scheduling process sent by the vehicle communication terminal, and/or when determining any one of the semi-persistent scheduling process expires according to the effective duration of the semi-persistent scheduling.

In the above embodiment, by receiving the notification message to activate the any one of semi-persistent scheduling process sent by the vehicle communication terminal, and/or determining any one of the semi-persistent scheduling process expires according to the effective duration of the semi-persistent scheduling, the semi-persistent scheduling process can be activated, so that the base station can release the time-frequency resources corresponding to the semi-persistent scheduling process in time, waste of resources can be avoided.

In any one of the above embodiments, optionally, determine the semi-persistent scheduling process needs to be activated according to the changed message feature and/or the message feature of the new vehicle communication service, specifically includes: selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

In the above embodiment, by respectively comparing the semi-persistent scheduling period, the time-frequency resource size allocated by the semi-persistent scheduling, the activation time of the semi-persistent scheduling with the message period, the message size, and the transmission time offset of the vehicle communication service, respectively, the semi-persistent scheduling process can be selected. Thus, a most appropriate semi-persistent scheduling process can be selected, and the semi-persistent scheduling that can better apply to different vehicle communication services can be ensured.

In any one of the above embodiments, optionally, the resource scheduling method for vehicle communication further includes: when determining that a plurality of vehicle communication services need to adopt a same semi-persistent scheduling process according to the changed message feature and/or the message feature of the new vehicle communication service, scheduling a highest priority vehicle communication service among the plurality of vehicle communication services based on the same semi-persistent scheduling process, after notifying the terminal to activate the same semi-persistent scheduling process.

In the above embodiment, if one semi-persistent scheduling process cannot schedule the plurality of vehicle communication services at the same time due to resource limitation, a vehicle communication service to be scheduled preferentially can be determined according to the priority of the vehicle communication service, thereby ensuring that the highest priority vehicle communication service can be preferentially scheduled.

According to a third embodiment of the present disclosure, a resource scheduling device for a vehicle communication is provided and executable on a vehicle communication terminal, the device includes: a first receiving unit, configured to receive a plurality of groups of configuration parameters for semi-persistent scheduling allocated by a base station, each of the plurality of groups of the configuration parameters corresponding to one semi-persistent scheduling process; a detection unit, configured to detect whether a message feature of a current vehicle communication service is changed, and/or whether a new vehicle communication service needs to be processed; a sending unit, configured to send a message feature after the current vehicle communication service is changed, and/or a message feature of a new vehicle communication service to the base station, when the message feature of the current vehicle communication service is detected to be changed, and/or is detected that the new vehicle communication message needs to be processed by the detection unit; a second receiving unit, configured to receive indication information from the base station according to the changed message feature and/or the message feature of the new vehicle communication service, and the indication information being used for indicating a semi-persistent scheduling process needs to be activated to the vehicle communication terminal; a processing unit, configured to activate the semi-persistent scheduling process needs to be activated based on configuration parameters corresponding to the semi-persistent scheduling process needs to be activated.

In the above embodiment, since one semi-persistent scheduling process corresponds to one group of configuration parameter, and different configuration parameters are applicable to vehicle communication services with corresponding message features, that is different semi-persistent scheduling processes corresponding to message features of the vehicle communication services, therefore, the vehicle communication terminal can detect whether the message feature of the current vehicle communication service is changed, and whether the new vehicle communication service needs to be processed, and report a detection result to the base station to assist the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

Regarding how the first receiving unit receive the plurality of groups of configuration parameters for semi-persistent scheduling allocated by the base station, the present disclosure provides following two manners:

A First Manner:

The first receiving unit specifically configured to, receive a Radio Network Temporary Identity (RNTI), an effective duration of the semi-persistent scheduling, and a period of the semi-persistent scheduling corresponding to each of the plurality of groups of the configuration parameters of the plurality configuration parameters sent by the base station through a Radio Resource Control (RRC) signaling.

In the first manner, different configuration parameters correspond to different RNTIs, that is, different semi-persistent scheduling processes can be distinguished by the RNTI. Specifically, the vehicle communication terminal can demodulate the time-frequency resources corresponding to different semi-persistent scheduling processes based on the RNTI.

A Second Manner:

The first receiving unit specifically configured to, receive the RNTI for the semi-persistent scheduling sent by the base station through the RRC signaling, and receive the identification information, the effective duration of the semi-persistent scheduling, and the period of the semi-persistent scheduling corresponding to each of the plurality of groups of the configuration parameters of the plurality configuration parameters sent by the base station through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal can demodulate the time-frequency resources corresponding to different semi-persistent scheduling processes based on the identification information in the RNTI and the DCI signaling.

In any one of the above embodiments, optionally, the sending unit further configured to, when it is determined that any one of semi-persistent scheduling process needs to be activated, send a notification message to activate the any one of the semi-persistent scheduling process to the base station.

In the above embodiment, by determining that any one of semi-persistent scheduling process needs to be activated, sending a notification message to activate the semi-persistent scheduling process to the base station, so that the base station can release the time-frequency resources corresponding to the semi-persistent scheduling process in time, waste of resources can be avoided. When the vehicle communication terminal determines that it is not necessary to process a certain vehicle communication service, it is determined that the semi-persistent scheduling process corresponding to the vehicle communication service needs to be activated. In addition, when the effective duration of the semi-persistent scheduling process expires, the vehicle communication terminal determines that it is also necessary to activate the semi-persistent scheduling process scheduling process needs to be activated, but in this case, it is not necessary to send the notification message to the base station, because the base station can voluntarily determine according to the configuration parameters corresponding to the semi-persistent scheduling process.

In any one of the above embodiments, optionally, the sending unit specifically configured to send the message feature after the current vehicle communication service is changed and/or the message feature of the new vehicle communication service to the base station through a medium access control unit signaling or the RRC signaling.

In any one of the above embodiments, optionally, the message feature includes at least one or a combination of the following: a message period, a message size, a transmission time offset, a priority of a vehicle communication service, a modulation coding manner adopted by the vehicle communication messages.

The transmission time offset can be used to determine a time point when the vehicle communication message is sent in the next cycle. Specifically, the transmission time offset can be represented by a sub-frame number.

According to a forth embodiment of the present disclosure, another resource scheduling device for a vehicle communication is provided and executable on a base station, the device includes: a first sending unit, configured to send a plurality of groups of configuration parameters for semi-persistent scheduling to a vehicle communication terminal, each of the plurality of groups of the configuration parameters corresponding to one semi-persistent scheduling process; a receiving unit, configured to receive a message feature after a current vehicle communication service is changed sent by the vehicle communication terminal, and/or a message feature of a new vehicle communication service needs to be processed; a determination unit, configured to determine the semi-persistent scheduling process that needs to be activated according to the changed message feature and/or the message feature of the new vehicle communication service; a second sending unit, configured to send indication information to the vehicle communication terminal, to enable the vehicle communication terminal to activate the semi-persistent scheduling process needs to be activated.

In the above embodiment, by sending the plurality of groups of configuration parameters for semi-persistent scheduling to the vehicle communication terminal, the vehicle communication terminal can activate the corresponding semi-persistent scheduling process based on the configuration parameters for the semi-persistent scheduling when receiving the indication information from the base station. Meanwhile, since one semi-persistent scheduling process corresponds to one group of the configuration parameter, and different configuration parameters are applicable to vehicle communication services with corresponding message features, that is different semi-persistent scheduling processes correspond to message features of the vehicle communication services. Therefore, by receiving the reported information sent by the vehicle communication terminal, that is, the changed message feature of the current vehicle communication service and/or the message feature of the new vehicle communication service, so that the reported information of the vehicle communication terminal can assist the base station to determine the semi-persistent scheduling process needs to be activated. It can be ensured that the semi-persistent scheduling process can be better applied to the changes in vehicle communication services, and also enabled parallel processing of the plurality of types of vehicle communication services, which are beneficial to improve resource utilization efficiency and system throughput capacity.

Regarding how the first sending unit send the plurality of groups of configuration parameters for semi-persistent scheduling to the vehicle communication terminal, the present disclosure provides following two manners:

A First Manner:

The first sending unit specially configured to, send a Radio Network Temporary Identity (RNTI), an effective duration of the semi-persistent scheduling, and a period of the semi-persistent scheduling corresponding to each of the plurality of groups of the configuration parameters of the plurality configuration parameters to the vehicle communication terminal through a Radio Resource Control (RRC) signaling.

In the first manner, different configuration parameters correspond to different RNTIs, that is, different semi-persistent scheduling processes can be distinguished by the RNTI. The vehicle communication terminal can demodulate the time-frequency resources corresponding to different semi-persistent scheduling processes based on the RNTI.

A Second Manner:

The first sending unit specially configured to, send the RNTI for the semi-persistent scheduling to the vehicle communication terminal through the RRC signaling, and send the identification information, the effective duration of the semi-persistent scheduling, and the period of the semi-persistent scheduling corresponding to each of the plurality of groups of the configuration parameters of the plurality configuration parameters to the vehicle communication terminal through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal may demodulate time-frequency resources corresponding to different semi-persistent scheduling processes based on the identification information in the RNTI and the DCI signaling.

In any one of the above embodiments, optionally, the resource scheduling device for the vehicle communication further includes: a processing unit, configured to activate any one of the semi-persistent scheduling process, when receiving a notification message to activate the any one of semi-persistent scheduling process sent by the vehicle communication terminal, and/or when determining any one of the semi-persistent scheduling process expires according to the effective duration of the semi-persistent scheduling.

In the above embodiment, by receiving the notification message to activate the any one of semi-persistent scheduling process sent by the vehicle communication terminal, and/or determining any one of the semi-persistent scheduling process expires according to the effective duration of the semi-persistent scheduling, the semi-persistent scheduling process can be activated, so that the base station can release the time-frequency resources corresponding to the semi-persistent scheduling process in time, waste of resources can be avoided.

In any one of the above embodiments, optionally, the determination unit specially configured to, determine the semi-persistent scheduling process needs to be activated according to the changed message feature and/or the message feature of the new vehicle communication service, specifically includes: selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

In the above embodiment, by comparing the semi-persistent scheduling period, the time-frequency resource size allocated by the semi-persistent scheduling, the activation time of the semi-persistent scheduling with the message period, the message size, and the transmission time offset of the vehicle communication service, respectively, the semi-persistent scheduling process can be selected. So that a most appropriate semi-persistent scheduling process can be selected, and the semi-persistent scheduling that can better apply to different vehicle communication services can be ensured.

In any one of the above embodiments, optionally, the resource scheduling device for vehicle communication further includes: a notification unit, configured to, when determining that a plurality of vehicle communication services need to adopt a same semi-persistent scheduling process according to the changed message feature and/or the message feature of the new vehicle communication service, schedule a highest priority vehicle communication service among the plurality of vehicle communication services based on the same semi-persistent scheduling process, after notifying the terminal to activate the same semi-persistent scheduling process.

In the above embodiment, if one semi-persistent scheduling process cannot schedule the plurality of vehicle communication services at the same time due to resource limitation, a vehicle communication service to be scheduled preferentially can be determined according to the priority of the vehicle communication service, thereby ensuring that the highest priority vehicle communication service can be preferentially scheduled.

According to a fifth embodiment of the present disclosure, a terminal is provided and includes: the resource scheduling device for vehicle communication of the above third embodiment.

According to a sixth embodiment of the present disclosure, a base station is provided and includes: the resource scheduling device for vehicle communication of the above forth embodiment.

According to the above embodiments, the reported information of the terminal can assist the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

### BRIEF DESCRIPTION OF THE DRAWINGS

FIG. 1 shows a schematic flow chart of a first embodiment of a resource scheduling method for a vehicle communication according to the present disclosure;

FIG. 2 shows a schematic flow chart of a second embodiment of a resource scheduling method for a vehicle communication according to the present disclosure;

FIG. 3 shows a schematic flow chart of a third embodiment of a resource scheduling method for a vehicle communication according to the present disclosure;

FIG. 4 shows a schematic structural diagram of a first embodiment of a specific way in which a base station sends a plurality of SPS configurations to V-UE according to the present disclosure;

FIG. 5 shows a schematic structural diagram of a second embodiment of a specific way in which a base station sends a plurality of SPS configurations to V-UE according to the present disclosure;

FIG. 6 shows a schematic structural diagram of a first embodiment of a resource scheduling device for a vehicle communication according to the present disclosure;

FIG. 7 shows a schematic structural diagram of a first embodiment of a terminal according to the present disclosure;

FIG. 8 shows a schematic structural diagram of a second embodiment of a resource scheduling device for a vehicle communication according to the present disclosure;

FIG. 9 shows a schematic structural diagram of a first embodiment of a base station according to the present disclosure;

FIG. 10 shows a schematic structural diagram of a second embodiment of a terminal according to the present disclosure;

FIG. 11 shows a schematic structural diagram of a second embodiment of a base station according to the present disclosure.

### DETAILED DESCRIPTION

For clarity of illustration of objectives, features and advantages of the present disclosure, the drawings combined with detailed description illustrate the embodiments of the present disclosure hereinafter. It is noted that embodiment of the present disclosure and features of the embodiments can be combined, when there is no conflict.

Various details are described in the following descriptions for better understanding of the present disclosure, however, the present disclosure may also be implemented in other ways other than those described herein. The scope of the present disclosure is not to be limited by the specific embodiments disclosed below.

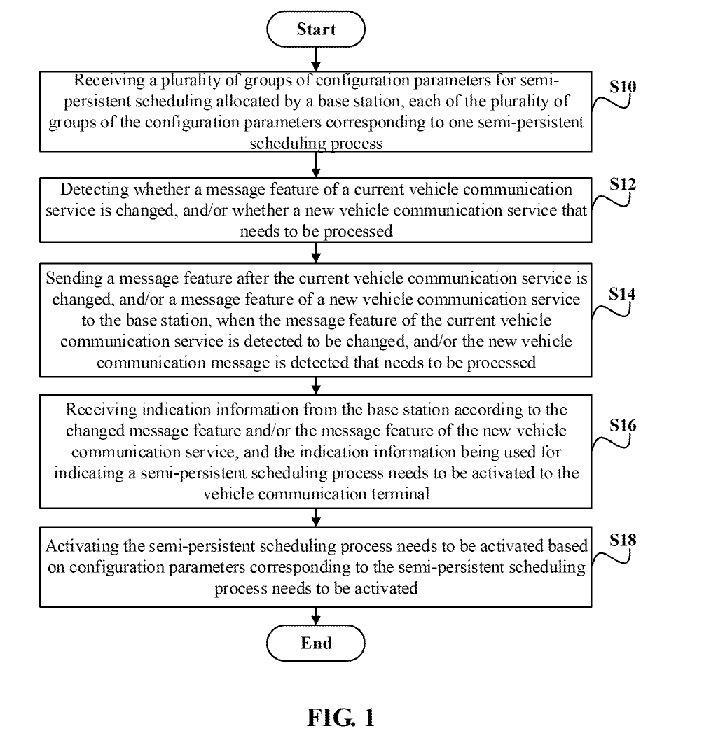

FIG. 1 shows a schematic flow chart of a first embodiment of a resource scheduling method for vehicle communication according to the present disclosure.

The resource scheduling method for vehicle communication of FIG. 1 is executable on a vehicle communication terminal. Specially, as shown in FIG. 1, the resource scheduling method includes:

Step S10, receiving a plurality of groups of configuration parameters for semi-persistent scheduling allocated by a base station, each of the plurality of groups of the configuration parameters corresponding to one semi-persistent scheduling process.

Different configuration parameters for semi-persistent scheduling corresponding to vehicle communication services, that is different semi-persistent scheduling processes corresponding to message features of the vehicle communication services. By receiving the plurality of groups of configuration parameters for semi-persistent scheduling allocated by the base station, when receiving indication information that being used for indicating a semi-persistent scheduling process needs to be activated sent by the base station, the corresponding semi-persistent scheduling process can be activated based on the corresponding configuration parameters.

Specially, regarding how to receive the plurality of groups of configuration parameters for semi-persistent scheduling allocated by the base station of the step S10, the present disclosure provides following two manners:

A First Manner:

Receiving a Radio Network Temporary Identity (RNTI), an effective duration of the semi-persistent scheduling, and a period of the semi-persistent scheduling corresponding to each of the plurality of groups of the configuration parameters of the plurality configuration parameters sent by the base station through a Radio Resource Control (RRC) signaling.

In the first manner, different configuration parameters correspond to different RNTIs, that is, different semi-persistent scheduling processes can be distinguished by the RNTI. Specifically, the vehicle communication terminal can demodulate the time-frequency resources corresponding to different semi-persistent scheduling processes based on the RNTI.

A Second Manner:

Receiving the RNTI for the semi-persistent scheduling sent by the base station through the RRC signaling, and receiving the identification information, the effective duration of the semi-persistent scheduling, and the period of the semi-persistent scheduling corresponding to each of the plurality of groups of the configuration parameters of the plurality of configuration parameters sent by the base station through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal can demodulate the time-frequency resources corresponding to different semi-persistent scheduling processes based on the identification information in the RNTI and the DCI signaling.

Step S12, detecting whether a message feature of a current vehicle communication service is changed, and/or whether a new vehicle communication service that needs to be processed.

Since different semi-persistent scheduling processes corresponding to message features of the vehicle communication services, therefore, It can be determined whether the semi-persistent scheduling process needs to be adjusted by detecting whether the message feature of the current vehicle communication service is changed, and whether the new vehicle communication service needs to be processed.

The above message feature includes at least one or a combination of the following: a message period, a message size, a transmission time offset, a priority of a vehicle communication service, a modulation coding manner adopted by the vehicle communication messages.

The transmission time offset can be used to determine a time point when the vehicle communication message is sent in the next cycle. Specifically, the transmission time offset can be represented by a sub-frame number.

Step S14, sending a message feature after the current vehicle communication service is changed, and/or a message feature of a new vehicle communication service to the base station, when the message feature of the current vehicle communication service is detected to be changed, and/or the new vehicle communication message is detected that needs to be processed.

Specifically, the message feature after the current vehicle communication service is changed, and/or the message feature of a new vehicle communication service can be sent to the base station through a medium access control unit signaling or the RRC signaling.

Step S16, receiving indication information from the base station according to the changed message feature and/or the message feature of the new vehicle communication service, and the indication information being used for indicating a semi-persistent scheduling process needs to be activated to the vehicle communication terminal.

Step S18, activating the semi-persistent scheduling process needs to be activated based on configuration parameters corresponding to the semi-persistent scheduling process needs to be activated.

In step S18, specifically, the vehicle communication terminal demodulates a time-frequency resource for semi-persistent scheduling according to the configuration parameter corresponding to the semi-persistent scheduling process needs to be activated, and transmits the vehicle communication message based on the time-frequency resource. When the vehicle communication terminal receives the configuration parameters for the semi-persistent scheduling according to the first manner, the time-frequency resource corresponding to the semi-persistent scheduling process can be demodulated based on the RNTI. When the vehicle communication terminal receives the configuration parameters for the semi-persistent scheduling according to the second manner, the time-frequency resources corresponding to the semi-persistent scheduling process can be demodulated based on the identifier information in the RNTI signaling and the DCI signaling.

Moreover, the above resource scheduling method for the vehicle communication further includes: when it is determined that any one of semi-persistent scheduling process needs to be activated, sending a notification message to activate the any one of the semi-persistent scheduling process to the base station. Specifically, by determining that the any one of semi-persistent scheduling process needs to be activated, sending a notification message to activate the semi-persistent scheduling process to the base station, so that the base station can release the time-frequency resources corresponding to the semi-persistent scheduling process in time, waste of resources can be avoided. When the vehicle communication terminal determines that it is not necessary to process a certain vehicle communication service, it is determined that the semi-persistent scheduling process corresponding to the vehicle communication service needs to be activated. In addition, when the effective duration of the semi-persistent scheduling process expires, the vehicle communication terminal determines that it is also necessary to activate the semi-persistent scheduling process scheduling process needs to be activated, but in this case, it is not necessary to send the notification message to the base station, because the base station can voluntarily determine according to the configuration parameters corresponding to the semi-persistent scheduling process.

In the embodiments shown in FIG. 1, when the vehicle communication terminal detects that the message feature of the current vehicle communication service changes and/or the message feature of the new vehicle communication service, needs to be processed, the detection result is reported to the base station, which may be assisted the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

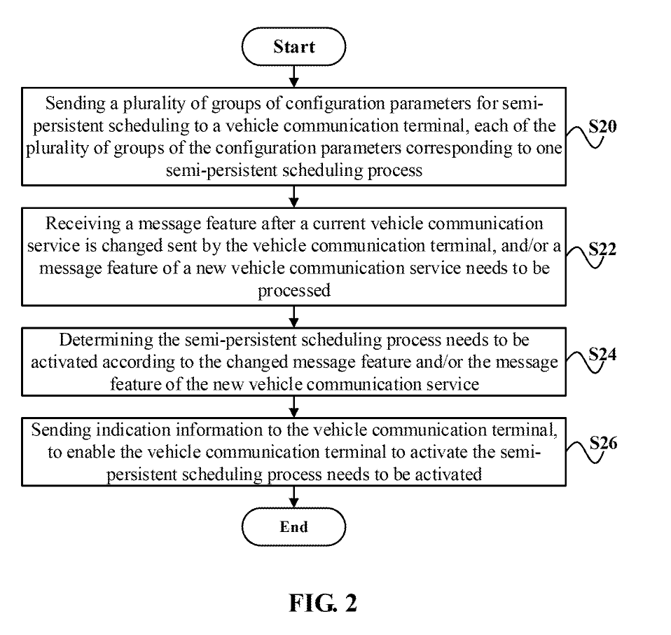

FIG. 2 shows a schematic flow chart of a second embodiment of a resource scheduling method for vehicle communication according to the present disclosure.

The resource scheduling method for vehicle communication of FIG. 1 is executable on a base station. Specially, as shown in FIG. 2, the resource scheduling method includes:

Step S20, sending a plurality of groups of configuration parameters for semi-persistent scheduling to a vehicle communication terminal, each of the plurality of groups of the configuration parameters corresponding to one semi-persistent scheduling process.

In step S20, by sending the plurality of groups of configuration parameters for semi-persistent scheduling to the vehicle communication terminal, the vehicle communication terminal can activate the corresponding semi-persistent scheduling process based on the configuration parameters for the semi-persistent scheduling when receiving the indication information from the base station.

Specifically, regarding how to send the plurality of groups of configuration parameters for semi-persistent scheduling to the vehicle communication terminal of step S20, the present disclosure provides following two manners:

A First Manner:

Sending a Radio Network Temporary Identity (RNTI), an effective duration of the semi-persistent scheduling, and a period of the semi-persistent scheduling corresponding to each of the plurality of groups of the configuration parameters to the vehicle communication terminal through a Radio Resource Control (RRC) signaling.

In the first manner, different configuration parameters correspond to different RNTIs, that is, different semi-persistent scheduling processes can be distinguished by the RNTI. The vehicle communication terminal can demodulate the time-frequency resources corresponding to different semi-persistent scheduling processes based on the RNTI.

A Second Manner:

Sending the RNTI for the semi-persistent scheduling to the vehicle communication terminal through the RRC signaling, and sending the identification information, the effective duration of the semi-persistent scheduling, and the period of the semi-persistent scheduling corresponding to each of the plurality of groups of the configuration parameters of the plurality configuration parameters to the vehicle communication terminal through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal may demodulate time-frequency resources corresponding to different semi-persistent scheduling processes based on the identification information in the RNTI and the DCI signaling.

Step S22, receiving a message feature after a current vehicle communication service is changed sent by the vehicle communication terminal, and/or a message feature of a new vehicle communication service needs to be processed.

Specifically, the base station can receive the message feature after the current vehicle communication service is changed sent by the vehicle communication terminal through a medium access control unit signaling or the RRC signaling, and/or the message feature of a new vehicle communication service needs to be processed.

Step S24, determining the semi-persistent scheduling process needs to be activated according to the changed message feature and/or the message feature of the new vehicle communication service.

In an embodiment of the present disclosure, the step S24 specifically includes: selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

In the above embodiment, by respectively comparing the semi-persistent scheduling period, the time-frequency resource size allocated by the semi-persistent scheduling, the activation time of the semi-persistent scheduling with the message period, the message size and the transmission time offset of the vehicle communication service, the semi-persistent scheduling process can be selected. Thus, a most appropriate semi-persistent scheduling process can be selected, and the semi-persistent scheduling that can better apply to different vehicle communication services can be ensured.

Step S26, sending indication information to the vehicle communication terminal, to enable the vehicle communication terminal to activate the semi-persistent scheduling process needs to be activated.

After the base station sends the indication information to the vehicle communication terminal, the vehicle communication terminal can activate the semi-persistent scheduling process based on the configuration parameters corresponding to the semi-persistent scheduling process needs to be activated.

Moreover, the above resource scheduling method for the vehicle communication further includes: activating any one of the semi-persistent scheduling process, when receiving a notification message to activate any one of semi-persistent scheduling process sent by the vehicle communication terminal, and/or when determining any one of the semi-persistent scheduling process expires according to the effective duration of the semi-persistent scheduling. by receiving the notification message to activate any one of semi-persistent scheduling process sent by the vehicle communication terminal, and/or determining any one of the semi-persistent scheduling process expires according to the effective duration of the semi-persistent scheduling, the semi-persistent scheduling process can be activated, so that the base station can release the time-frequency resources corresponding to the semi-persistent scheduling process in time, waste of resources can be avoided.

In an embodiment of the present disclosure, the above resource scheduling method for the vehicle communication further includes: when determining that a plurality of vehicle communication services need to adopt a same semi-persistent scheduling process according to the changed message feature and/or the message feature of the new vehicle communication service, scheduling a highest priority vehicle communication service among the plurality of vehicle communication services based on the same semi-persistent scheduling process, after notifying the terminal to activate the same semi-persistent scheduling process.

In the above embodiment, if one semi-persistent scheduling process cannot schedule the plurality of vehicle communication services at the same time due to resource limitation, a vehicle communication service to be scheduled preferentially can be determined according to the priority of the vehicle communication service, thereby ensuring that the highest priority vehicle communication service can be preferentially scheduled.

In the embodiments shown in FIG. 2, the base station can receive the reported information sent by the vehicle communication terminal, that is the message feature of the current vehicle communication service changes, and/or the message feature of the new vehicle communication service needs to be processed, thus the reported information of the vehicle communication terminal can assist the base station to determine the semi-persistent scheduling process needs to be activated. It can be further ensured that the semi-persistent scheduling process can be better applied to the changes in vehicle communication services, and also enabled parallel processing of a plurality of types of vehicle communication services, which are beneficial to improve resource utilization efficiency and system throughput capacity.

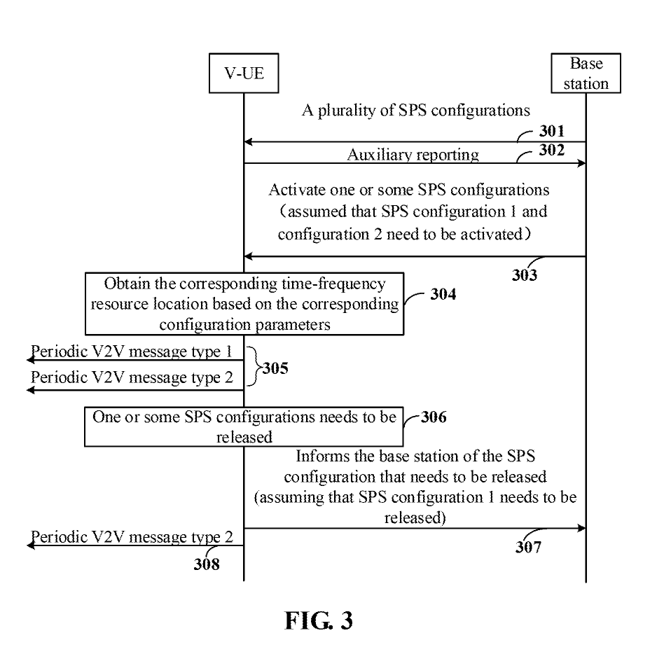

The above described resource scheduling methods in the embodiments of the present disclosure from the aspects of the vehicle communication terminal and the base station, and the technical solutions of the resource scheduling methods implemented by the two are described in detail below with reference to FIG. 3 to FIG. 5.

The resource scheduling method proposed by the present disclosure mainly includes four processes, that is, a process in which a base station initializes of a plurality of SL SPS configurations, a process in which V-UE performs auxiliary reporting, a process in which a base station activates an SPS configuration, and a process of releasing (activating) the SPS configuration. The following is described in detail below with reference to FIG. 3:

As shown in FIG. 3, a resource scheduling method for a vehicle communication according to a third embodiment of the present disclosure, includes:

Step 301, the base station sends a plurality of SPS configurations to the V-UE. The step is the process in which the base station initializes the plurality of SL SPS configurations. Step 301 mainly include the following two implementation methods:

A First Method:

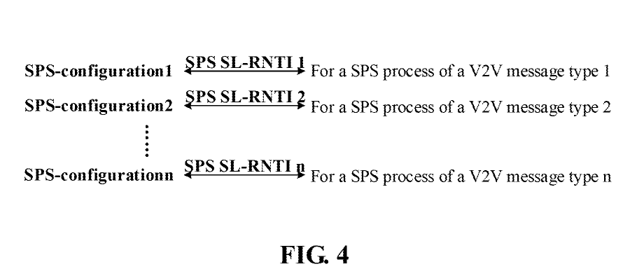

As shown in FIG. 4, a mapping relationship of the SPS configuration is a many-to-many mapping relationship. The base station configures a plurality of different SPS configurations to the V-UE through a RRC signaling. The parameters in the RRC signaling include different identifiers of the SPS process corresponding to different V2V message types transmitted by the V-UE (that is, SPS SL-RNTI), effective duration of the SPS, a scheduling period of the SPS, and the like. In this method, different SPS configurations can be distinguished by the SPS SL-RNTI.

A Second Method:

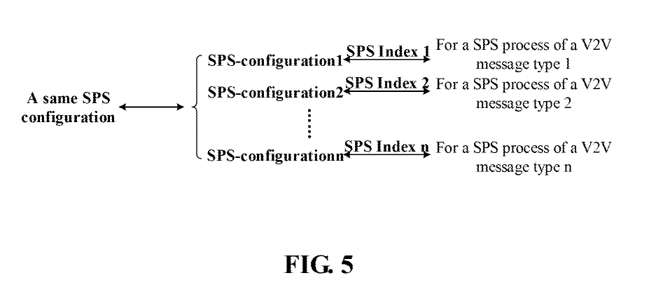

As shown in FIG. 5, a mapping relationship of the SPS configuration is a one-to-many mapping relationship. The base station configures a same SPS configurations to the V-UE through a RRC signaling. The RRC signaling include only one identifiers of the V-UE (that is, SPS SL-RNTI). Moreover, the base station configures a plurality of different SPS configurations to the V-UE through a DCI signaling. The DCI signaling includes identifiers of different SPS process (that is, SPS Index), effective duration of the SPS, a scheduling period of the SPS, and the like. In this method, different SPS configurations can be distinguished by the SPS Index in the DCI signaling.

With continued reference to FIG. 3, the resource scheduling method further includes:

Step 302, the V-UE performs an auxiliary reporting. The step is the auxiliary reporting process performed by the V-UE.

Specifically, when the V-UE detects that a current V2V and/or a V2V message size and/or an initial time offset of the V2V message transmission has changed, and/or a new V2V message type has occurred, the V-UE is trigged to performs auxiliary reporting.

The auxiliary reporting performed by the V-UE can use a Media Access Control (MAC) signaling, a Control Element (CE) signaling or the RRC signaling. The parameters in those signaling include: the V2V message period, the V2V message size, an initial time offset of the V2V message transmission (offset can be a current sub-frame number). Optionally, the parameters in those signaling also include: a service priority of the V2V message and a Modulation and Coding Scheme (MCS) used for the V2V message transmission.

The auxiliary reporting performed by the V-UE is mainly used for the activation/deactivation process of the SPS configuration, because for the periodic V2V message in the Internet of Vehicles, the V-UE is the best location for obtaining the V2V message size/cycle dynamic change information. By determining which SPS configuration to use through the base station, it may cause a certain delay and fail to obtain the best performance of resource scheduling.

With continued reference to FIG. 3, the resource scheduling method further includes:

Step 303, the base station sends an indication to the V-UE to activate one or some SPS configurations. It is assumed that SPS configuration 1 and configuration 2 need to be activated.

Specifically, the base station determines which one or some SPS configurations are activated according to the parameters that auxiliary reported by the UE. The SPS configurations include that the SPS scheduling period is equal to the V2V message period, and a time-frequency resource size of the SPS configuration is equal to the V2V message size, and activation time of the SPS configuration is the same as the initial time offset of the V2V message transmission.

Step S304, the V-UE demodulates a Physical Downlink Control Channel (PDCCH) to obtain a corresponding time-frequency resource location based on the corresponding configuration parameters.

Specifically, the UE demodulates the PDCCH to obtain the time-frequency resource location of the corresponding V2V message transmission according to the SPS SL-RNTI (the first method in step 301) or the SPS SL-RNTI in combination with the SPS Index (the second method in step 301).

Step 303 and step 304 are processes for activating the SPS configuration by the base station.

Step 305, the V-UE sends a periodic V2V message type 1 and a periodic V2V message type 2 (assuming that SPS configuration 1 and configuration 2 are activated).

Step 306, the V-UE determines that one or some SPS configurations need to be released.

Step 307, the V-UE informs the base station of the SPS configuration that needs to be released (assuming that SPS configuration 1 needs to be released). Specifically, the V-UE can inform the base station of the SPS configuration that needs to be released through the RRC signaling.

Steps 305 to 307 are the processes of releasing (deactivating) the SPS configuration described above. In addition, it also can be determined whether the SPS configuration needs to be deactivated by the V-UE based on the effective duration included in the parameters allocated by the base station in step 301. In this case, the V-UE does not need to send a notification message to the base station, because the base station can voluntarily determine according to the configuration parameters corresponding to the semi-persistent scheduling process.

Step 308, after releasing the SPS configuration 1, the V-UE transmits only the periodic V2V message type 2.

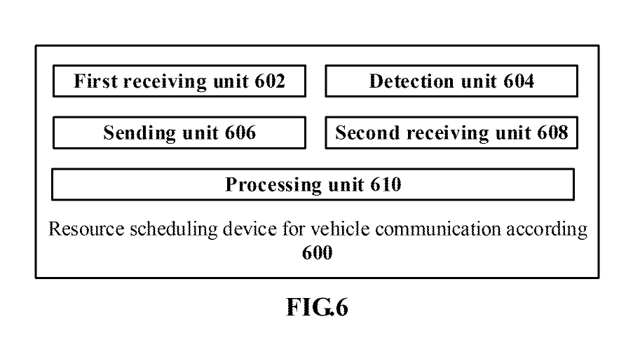

FIG. 6 shows a schematic structural diagram of a first embodiment of a resource scheduling device for a vehicle communication according to the present disclosure;

The resource scheduling device for vehicle communication of FIG. 1 is executable on a vehicle communication terminal. As shown in FIG. 6, a resource scheduling device 600 for vehicle communication according to the first embodiment of the present disclosure, includes: a first receiving unit 602, a detection unit 604, a sending unit 606, a second receiving unit 608 and a processing unit 610.

The first receiving unit 602, configured to receive a plurality of groups of configuration parameters for semi-persistent scheduling allocated by a base station, each of the plurality of groups of the configuration parameters corresponding to one semi-persistent scheduling process; the detection unit 604, configured to detect whether a message feature of a current vehicle communication service is changed, and/or whether a new vehicle communication service needs to be processed; the sending unit 606, configured to send a message feature after the current vehicle communication service is changed, and/or a message feature of a new vehicle communication service to the base station, when the message feature of the current vehicle communication service is detected to be changed, and/or is detected that the new vehicle communication message needs to be processed by the detection unit; the second receiving unit 608, configured to receive indication information from the base station according to the changed message feature and/or the message feature of the new vehicle communication service, and the indication information being used for indicating a semi-persistent scheduling process needs to be activated to the vehicle communication terminal; the processing unit 610, configured to activate the semi-persistent scheduling process needs to be activated based on configuration parameters corresponding to the semi-persistent scheduling process needs to be activated.

In the above embodiment, since one semi-persistent scheduling process corresponds to one group of configuration parameter, and different configuration parameters are applicable to vehicle communication services with corresponding message features, that is different semi-persistent scheduling processes corresponding to message features of the vehicle communication services, therefore, the vehicle communication terminal can detect whether the message feature of the current vehicle communication service is changed, and whether the new vehicle communication service needs to be processed, and report a detection result to the base station to assist the base station to determine the semi-persistent scheduling process needs to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

Regarding how the first receiving unit 602 receive the plurality of groups of configuration parameters for semi-persistent scheduling allocated by the base station, the present disclosure provides following two manners:

A First Manner:

The first receiving unit 602 specifically configured to, receive a Radio Network Temporary Identity (RNTI), an effective duration of the semi-persistent scheduling, and a period of the semi-persistent scheduling corresponding to each of the plurality of groups of the configuration parameters of the plurality configuration parameters sent by the base station through a Radio Resource Control (RRC) signaling.

In the first manner, different configuration parameters correspond to different RNTIs, that is, different semi-persistent scheduling processes can be distinguished by the RNTI. Specifically, the vehicle communication terminal can demodulate the time-frequency resources corresponding to different semi-persistent scheduling processes based on the RNTI.

A Second Manner:

The first receiving unit 602 specifically configured to, receive the RNTI for the semi-persistent scheduling sent by the base station through the RRC signaling, and receive the identification information, the effective duration of the semi-persistent scheduling, and the period of the semi-persistent scheduling corresponding to each of the plurality of groups of the configuration parameters of the plurality configuration parameters sent by the base station through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal can demodulate the time-frequency resources corresponding to different semi-persistent scheduling processes based on the identification information in the RNTI and the DCI signaling.

In any one of the above embodiments, optionally, the sending unit 606 further configured to, when it is determined that any one of semi-persistent scheduling process needs to be activated, send a notification message to activate the any one of the semi-persistent scheduling process to the base station.

In the above embodiment, by determining that any one of semi-persistent scheduling process needs to be activated, sending a notification message to activate the semi-persistent scheduling process to the base station, so that the base station can release the time-frequency resources corresponding to the semi-persistent scheduling process in time, waste of resources can be avoided. When the vehicle communication terminal determines that it is not necessary to process a certain vehicle communication service, it is determined that the semi-persistent scheduling process corresponding to the vehicle communication service needs to be activated. In addition, when the effective duration of the semi-persistent scheduling process expires, the vehicle communication terminal determines that it is also necessary to activate the semi-persistent scheduling process scheduling process needs to be activated, but in this case, it is not necessary to send the notification message to the base station, because the base station can voluntarily determine according to the configuration parameters corresponding to the semi-persistent scheduling process.

In any one of the above embodiments, optionally, the sending unit 606 specifically configured to, send the message feature after the current vehicle communication service is changed, and/or the message feature of the new vehicle communication service to the base station through a medium access control unit signaling or the RRC signaling.

In anyone of the above embodiments, optionally, the message feature includes at least one or a combination of the following: a message period, a message size, a transmission time offset, a priority of a vehicle communication service, a modulation coding manner adopted by the vehicle communication messages.

The transmission time offset can be used to determine a time point when the vehicle communication message is sent in the next cycle. Specifically, the transmission time offset can be represented by a sub-frame number.

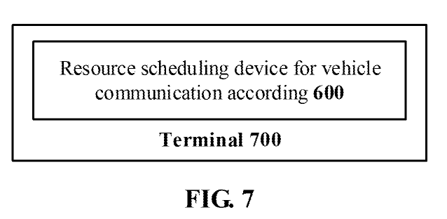

FIG. 7 shows a schematic structural diagram of a first embodiment of a terminal according to the present disclosure.

As shown in FIG. 7, a terminal 700 according to the first embodiment of the present disclosure, includes: the resource scheduling device 600 for vehicle communication as shown in FIG. 6.

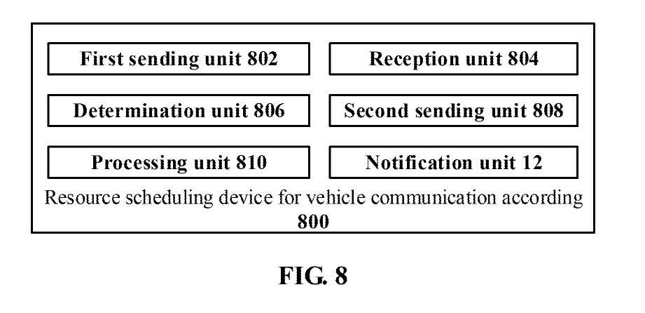

FIG. 8 shows a schematic structural diagram of a second embodiment of a resource scheduling device for a vehicle communication according to the present disclosure;

The resource scheduling device for a vehicle communication of FIG. 8 is executable on a base station. As shown in FIG. 8, a resource scheduling device 800 for vehicle communication according to the second embodiment of the present disclosure, includes: a first sending unit 802, a receiving unit 804, a determination unit 806, and a second sending unit 808.

The first sending unit 802, configured to send a plurality of groups of configuration parameters for semi-persistent scheduling to a vehicle communication terminal, each of the plurality of groups of the configuration parameters corresponding to one semi-persistent scheduling process; a receiving unit, configured to receive a message feature after a current vehicle communication service is changed sent by the vehicle communication terminal, and/or a message feature of a new vehicle communication service needs to be processed; a determination unit, configured to determine the semi-persistent scheduling process needs to be activated according to the changed message feature and/or the message feature of the new vehicle communication service; a second sending unit, configured to send indication information to the vehicle communication terminal, to enable the vehicle communication terminal to activate the semi-persistent scheduling process needs to be activated.

In the above embodiment, by sending the plurality of groups of configuration parameters for semi-persistent scheduling to the vehicle communication terminal, the vehicle communication terminal can activate the corresponding semi-persistent scheduling process based on the configuration parameters for the semi-persistent scheduling when receiving the indication information from the base station. Meanwhile, since one semi-persistent scheduling process corresponds to one group of the configuration parameter, and different configuration parameters are applicable to vehicle communication services with corresponding message features, that is different semi-persistent scheduling processes correspond to message features of the vehicle communication services. Therefore, by receiving the reported information sent by the vehicle communication terminal, that is, the changed message feature of the current vehicle communication service and/or the message feature of the new vehicle communication service, so that the reported information of the vehicle communication terminal can assist the base station to determine the semi-persistent scheduling process needs to be activated. It can be ensured that the semi-persistent scheduling process can be better applied to the changes in vehicle communication services, and also enabled parallel processing of the plurality of types of vehicle communication services, which are beneficial to improve resource utilization efficiency and system throughput capacity.

Regarding how the first sending unit 802 send the plurality of groups of configuration parameters for semi-persistent scheduling to the vehicle communication terminal, the present disclosure provides following two manners:

A First Manner:

The first sending unit 802 specially configured to, send a Radio Network Temporary Identity (RNTI), an effective duration of the semi-persistent scheduling, and a period of the semi-persistent scheduling corresponding to each of the plurality of groups of the configuration parameters of the plurality configuration parameters to the vehicle communication terminal through a Radio Resource Control (RRC) signaling.

In the first manner, different configuration parameters correspond to different RNTIs, that is, different semi-persistent scheduling processes can be distinguished by the RNTI. The vehicle communication terminal can demodulate the time-frequency resources corresponding to different semi-persistent scheduling processes based on the RNTI.

A Second Manner:

The first sending unit 802 specially configured to, send the RNTI for the semi-persistent scheduling to the vehicle communication terminal through the RRC signaling, and send the identification information, the effective duration of the semi-persistent scheduling, and the period of the semi-persistent scheduling corresponding to each of the plurality of groups of the configuration parameters to the vehicle communication terminal through a Downlink Control Information (DCI) signaling.

In the second manner, different configuration parameters correspond to different identification information, that is, different semi-persistent scheduling processes can be distinguished by the identification information in the DCI signaling. Specifically, the vehicle communication terminal may demodulate time-frequency resources corresponding to different semi-persistent scheduling processes based on the identification information in the RNTI and the DCI signaling.

In any one of the above embodiments, optionally, the resource scheduling device 800 for the vehicle communication further includes: a processing unit 810, configured to activate any one of the semi-persistent scheduling process, when receiving a notification message to activate any one of semi-persistent scheduling process sent by the vehicle communication terminal, and/or when determining any one of the semi-persistent scheduling process expires according to the effective duration of the semi-persistent scheduling.

In the above embodiment, by receiving the notification message to activate the any one of semi-persistent scheduling process sent by the vehicle communication terminal, and/or determining any one of the semi-persistent scheduling process expires according to the effective duration of the semi-persistent scheduling, the semi-persistent scheduling process can be activated, so that the base station can release the time-frequency resources corresponding to the semi-persistent scheduling process in time, waste of resources can be avoided.

In any one of the above embodiments, optionally, the determination unit 806 specially configured to, determine the semi-persistent scheduling process needs to be activated according to the changed message feature and/or the message feature of the new vehicle communication service, specifically includes: selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

In the above embodiment, by comparing the semi-persistent scheduling period, the time-frequency resource size allocated by the semi-persistent scheduling, the activation time of the semi-persistent scheduling with the message period, the message size, and the transmission time offset of the vehicle communication service, respectively, the semi-persistent scheduling process can be selected. So that a most appropriate semi-persistent scheduling process can be selected, and the semi-persistent scheduling that can better apply to different vehicle communication services can be ensured.

In any one of the above embodiments, optionally, the resource scheduling device 800 for vehicle communication further includes: a notification unit 812, configured to, when the determination unit 806 determines that a plurality of vehicle communication services need to adopt a same semi-persistent scheduling process according to the changed message feature and/or the message feature of the new vehicle communication service, schedule a highest priority vehicle communication service among the plurality of vehicle communication services based on the same semi-persistent scheduling process, after notifying the terminal to activate the same semi-persistent scheduling process.

In the above embodiment, if one semi-persistent scheduling process cannot schedule a plurality of vehicle communication services at the same time due to resource limitation, a vehicle communication service to be scheduled preferentially can be determined according to the priority of the vehicle communication service, thereby ensuring that the highest priority vehicle communication service can be preferentially scheduled.

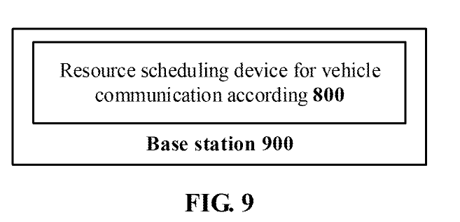

FIG. 9 shows a schematic structural diagram of a first embodiment of a base station according to the present disclosure.

As shown in FIG. 9, a base station 900 according to the first embodiment of the present disclosure, includes: the resource scheduling device 800 for vehicle communication as shown in FIG. 8.

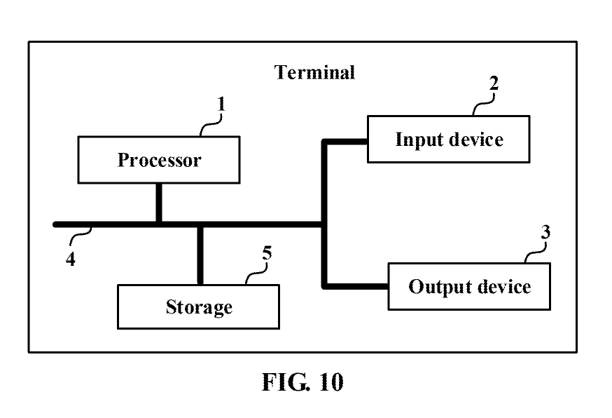

FIG. 10 shows a schematic structural diagram of a second embodiment of a terminal according to the present disclosure.

As shown in FIG. 10, the terminal according to the second embodiment of the present disclosure, includes: a processor 1, an input device 2, an output device 3 and a memory 5. In some embodiments of the present disclosure, the processor 1, the input device 2, the output device 3 and the memory 5 can be connected through a bus 4 or in other manners, FIG. 10 is connected through the bus 4 as an example.

The memory 5 stores a set of program codes. The processor 1 is used to invoke the program codes stored in the memory 5 to execute the following operations:

Receiving a plurality of groups of configuration parameters for semi-persistent scheduling allocated by a base station through the input device 2, each of the plurality of groups of the configuration parameters corresponding to one semi-persistent scheduling process;

Detecting whether a message feature of a current vehicle communication service is changed, and/or whether a new vehicle communication service needs to be processed;

Sending a message feature after the current vehicle communication service is changed, and/or a message feature of a new vehicle communication service to the base station through the output device 3, when the message feature of the current vehicle communication service is detected to be changed, and/or it is detected that the new vehicle communication message needs to be processed;

Receiving indication information from the base station according to the changed message feature and/or the message feature of the new vehicle communication service through the input device 2, and the indication information being used for indicating a semi-persistent scheduling process needs to be activated to the vehicle communication terminal;

Activating the semi-persistent scheduling process needs to be activated, based on configuration parameters corresponding to the semi-persistent scheduling process needs to be activated

As an alternative embodiment, the processor 1 invokes the program codes stored in the memory 5, and the operation of receiving the plurality of groups of configuration parameters for semi-persistent scheduling allocated by the base station execute the following operations through the input device 2 is specifically:

Receiving a Radio Network Temporary Identity (RNTI), an effective duration of the semi-persistent scheduling, and a period of the semi-persistent scheduling corresponding to each of the plurality of groups of the configuration parameters sent by the base station through a Radio Resource Control (RRC) signaling; or

Receiving the Radio Network Temporary Identity for semi-persistent scheduling sent by the base station through the Radio Resource Control signaling; and receive the identification information, the effective duration of the semi-persistent scheduling, and the period of the semi-persistent scheduling corresponding to each of the plurality of groups of the configuration parameters of the plurality of configuration parameters sent by the base station through a Downlink Control Information (DCI) signaling.

As an alternative embodiment, the processor 1 invokes the program codes stored in the memory 5, and further to execute the following operations:

when it is determined that any one of semi-persistent scheduling process needs to be activated, sending a notification message to activate the any one of the semi-persistent scheduling process to the base station.

As an alternative embodiment, the processor 1 invokes the program codes stored in the memory 5, and the operation of Sending the message feature after the current vehicle communication service is changed, and/or the message feature of the new vehicle communication service to the base station through the output device 3 is specifically:

Sending the message feature after the current vehicle communication service is changed, and/or the message feature of the new vehicle communication service to the base station through a medium access control unit signaling or a Radio Resource Control signaling.

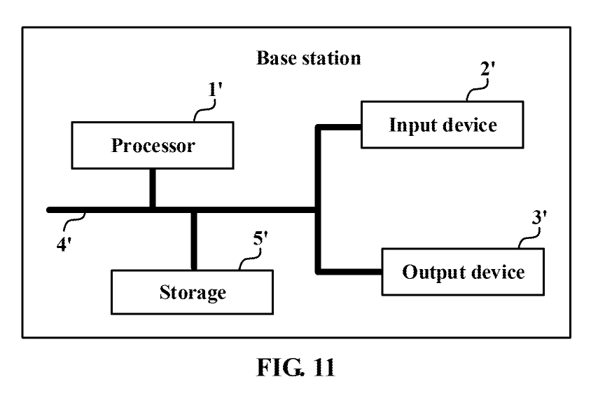

FIG. 11 shows a schematic structural diagram of a second embodiment of a base station according to the present disclosure.

As shown in FIG. 11, the base station according to the second embodiment of the present disclosure, includes: a processor 1′, an input device 2′, an output device 3′ and a memory 5′. In some embodiments of the present disclosure, the processor 1′, the input device 2′, the output device 3′ and the memory 5′ can be connected through a bus 4′ or in other manners, FIG. 11 is connected through the bus 4′ as an example.

The memory 5′ stores a set of program codes. The processor 1′ is used to invoke the program codes stored in the memory 5′ to execute the following operations:

Sending a plurality of groups of configuration parameters for semi-persistent scheduling to a vehicle communication terminal through the output device 3′, each of the plurality of groups of the configuration parameters corresponding to one semi-persistent scheduling process;

Receiving a message feature after a current vehicle communication service is changed sent by the vehicle communication terminal through the input device 2′, and/or a message feature of a new vehicle communication service needs to be processed;

Determining the semi-persistent scheduling process needs to be activated according to the changed message feature and/or the message feature of the new vehicle communication service;

Sending indication information to the vehicle communication terminal through the output device 3′, to enable the vehicle communication terminal to activate the semi-persistent scheduling process needs to be activated.

As an alternative embodiment, the processor 1′ invokes the program codes stored in the memory 5′, and the operation of sending the plurality of groups of configuration parameters for semi-persistent scheduling to the vehicle communication terminal through the output device 3′ is specifically:

Sending a Radio Network Temporary Identity (RNTI), an effective duration of the semi-persistent scheduling, and a period of the semi-persistent scheduling corresponding to each of the plurality of groups of the configuration parameters of the plurality configuration parameters to the vehicle communication terminal through a Radio Resource Control (RRC) signaling, or

Sending the Radio Network Temporary Identity for the semi-persistent scheduling to the vehicle communication terminal through the Radio Resource Control signaling, and send the identification information, the effective duration of the semi-persistent scheduling, and the period of the semi-persistent scheduling corresponding to each of the plurality of groups of the configuration parameters of the plurality configuration parameters to the vehicle communication terminal through a Downlink Control Information (DCI) signaling.

As an alternative embodiment, the processor 1′ invokes the program codes stored in the memory 5′, and further to execute the following operations:

Activating any one of the semi-persistent scheduling process, when receiving a notification message to activate any one of semi-persistent scheduling process sent by the vehicle communication terminal, and/or when determining any one of the semi-persistent scheduling process expires according to the effective duration of the semi-persistent scheduling through the input device 2′.

As an alternative embodiment, the processor 1′ invokes the program codes stored in the memory 5′, and further to execute the following operations:

Selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

As an alternative embodiment, the processor 1′ invokes the program codes stored in the memory 5′, and further to execute the following operations:

When determining that a plurality of vehicle communication services need to adopt a same semi-persistent scheduling process according to the changed message feature and/or the message feature of the new vehicle communication service, preferentially scheduling a highest priority vehicle communication service among the plurality of vehicle communication services based on the same semi-persistent scheduling process, after notifying the terminal to activate the same semi-persistent scheduling process.

The steps in the resource scheduling method for vehicle communication of the embodiment of the present disclosure can be sequentially adjusted, merged, and deleted according to actual requirements.

The resource scheduling device, the terminal, and the units in the base station for the vehicle communication of the embodiment of the present disclosure can be combined, divided, and deleted according to actual needs according to actual requirements.

Persons of ordinary skill in the art can understand that all or part of the processes of the above embodiments may be implemented by executing a computer program by related hardware. The program may be stored in a computer readable storage medium. The storage medium can include a Read-Only Memory (ROM), a Random Access Memory (RAM), a Programmable Read-only Memory (PROM), an Erasable Programmable Read Only Memory (EPROM), an One-time Programmable Read-Only Memory (OTPROM), an Electrically-Erasable Programmable Read-Only Memory (EEPROM), a Compact Disc Read-Only Memory (CD-ROM) or an optical disc storage, a disk storage, a tape storage or any other medium readable by a computer that can be used to carry or store data.

The present disclosure has been explicated above by referring to the drawings. An embodiment of the present disclosure is to provide a new resource scheduling solution for vehicle communication, so that the reported information of terminals can assist the base station to determine the semi-persistent scheduling processes that need to be activated. It can be ensured that the semi-persistent scheduling process can be better applied to the changes in vehicle communication services, and also enabled parallel processing of a plurality of types of vehicle communication services, which are beneficial to improve resource utilization efficiency and system throughput capacity.

The above mentioned descriptions are merely preferred embodiments of the present disclosure, and certainly, should not limit the scope of the present disclosure. Thus, any modification and equivalent according to the claims of the present disclosure, should be still within the scope of the present disclosure.

1. A resource scheduling method for a vehicle communication, executed in a vehicle communication terminal, the resource scheduling method comprising:
receiving a plurality of groups of configuration parameters for semi-persistent scheduling allocated by a base station, each of the plurality of groups of the configuration parameters corresponding to one semi-persistent scheduling process;
detecting whether a message feature of a current vehicle communication service is changed, and/or whether a new vehicle communication service needs to be processed;
sending a message feature after the current vehicle communication service is changed, and/or a message feature of a new vehicle communication service to the base station, when the message feature of the current vehicle communication service is detected to be changed, and/or it is detected that the new vehicle communication message needs to be processed;
receiving indication information from the base station according to the changed message feature and/or the message feature of the new vehicle communication service, and the indication information being used for indicating a semi-persistent scheduling process needs to be activated to the vehicle communication terminal; and
activating the semi-persistent scheduling process needs to be activated based on configuration parameters corresponding to the semi-persistent scheduling process needs to be activated.

2. The resource scheduling method for vehicle communication of claim 1, wherein receiving the plurality of groups of configuration parameters for semi-persistent scheduling allocated by the base station comprises:
receiving a Radio Network Temporary Identity (RNTI), an effective duration of the semi-persistent scheduling, and a period of the semi-persistent scheduling corresponding to each of the plurality of groups of the configuration parameters of the plurality of groups of configuration parameters sent by the base station through a Radio Resource Control (RRC) signaling; or
receiving the RNTI for semi-persistent scheduling sent by the base station through the RRC signaling; and receiving the identification information, the effective duration of the semi-persistent scheduling, and the period of the semi-persistent scheduling corresponding to each of the plurality of groups of the configuration parameters of the plurality configuration parameters sent by the base station through a Downlink Control Information (DCI) signaling.

3. The resource scheduling method for vehicle communication of claim 1, further comprising:
when it is determined that any one of semi-persistent scheduling process needs to be activated, sending a notification message to activate the any one of the semi-persistent scheduling process to the base station.

4. The resource scheduling method for vehicle communication of claim 1, further comprising:
sending the message feature after the current vehicle communication service is changed, and/or the message feature of the new vehicle communication service to the base station through a medium access control unit signaling or a RRC signaling.

5. The resource scheduling method for vehicle communication of claim 1, wherein the message feature comprises at least one or a combination of: a message period, a message size, a transmission time offset, a priority of a vehicle communication service, a modulation coding method adopted by the vehicle communication messages.

6. A resource scheduling method for vehicle communication, executed in a base station, the resource scheduling method comprising:
sending a plurality of groups of configuration parameters for semi-persistent scheduling to a vehicle communication terminal, each of the plurality of groups of the configuration parameters corresponding to one semi-persistent scheduling process;
receiving a message feature after a current vehicle communication service is changed sent by the vehicle communication terminal, and/or a message feature of a new vehicle communication service needs to be processed;
determining the semi-persistent scheduling process needs to be activated according to the changed message feature and/or the message feature of the new vehicle communication service; and
sending indication information to the vehicle communication terminal, to enable the vehicle communication terminal to activate the semi-persistent scheduling process needs to be activated.

7. The resource scheduling method for vehicle communication of claim 6, wherein sending a plurality of groups of configuration parameters for semi-persistent scheduling to the vehicle communication terminal, comprises:
sending a Radio Network Temporary Identity (RNTI), an effective duration of the semi-persistent scheduling, and a period of the semi-persistent scheduling corresponding to each of the plurality of groups of the configuration parameters of the plurality configuration parameters to the vehicle communication terminal through a Radio Resource Control (RRC) signaling, or
sending the Radio Network Temporary Identity for the semi-persistent scheduling to the vehicle communication terminal through the Radio Resource Control signaling, and sending the identification information, the effective duration of the semi-persistent scheduling, and the period of the semi-persistent scheduling corresponding to each of the plurality of groups of the configuration parameters of the plurality of groups of configuration parameters to the vehicle communication terminal through a Downlink Control Information (DCI) signaling.

8. The resource scheduling method for vehicle communication of claim 6, further comprising:
activating any one of the semi-persistent scheduling process, when receiving a notification message to activate any one of semi-persistent scheduling process sent by the vehicle communication terminal, and/or when determining any one of the semi-persistent scheduling process expires according to the effective duration of the semi-persistent scheduling.

9. The resource scheduling method for vehicle communication of claim 6, wherein determining the semi-persistent scheduling process needs to be activated according to the changed message feature and/or the message feature of the new vehicle communication service, comprises:
selecting a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

10. The resource scheduling method for vehicle communication of claim 6, further comprising:
when determining that a plurality of vehicle communication services need to adopt a same semi-persistent scheduling process according to the changed message feature and/or the message feature of the new vehicle communication service, preferentially scheduling a highest priority vehicle communication service among the plurality of vehicle communication services based on the same semi-persistent scheduling process, after notifying the terminal to activate the same semi-persistent scheduling process.

11. A vehicle communication, comprising:
at least one processor; and
a storage device storing a plurality of instructions, which when executed by the at least one processor, causes the at least one processor to:
receive a plurality of groups of configuration parameters for semi-persistent scheduling allocated by a base station, each of the plurality of groups of the configuration parameters corresponding to one semi-persistent scheduling process;
detect whether a message feature of a current vehicle communication service is changed, and/or detect whether a new vehicle communication service needs to be processed;
send a message feature after the current vehicle communication service is changed, and/or a message feature of a new vehicle communication service to the base station, when the message feature of the current vehicle communication service is detected to be changed, and/or it is detected that the new vehicle communication message needs to be processed by the detection unit;
receive indication information from the base station according to the changed message feature and/or the message feature of the new vehicle communication service, and the indication information being used for indicating a semi-persistent scheduling process needs to be activated to the vehicle communication terminal; and
activate the semi-persistent scheduling process needs to be activated based on configuration parameters corresponding to the semi-persistent scheduling process needs to be activated.

12. The vehicle communication of claim 11, wherein the plurality of instructions, when executed by the at least one processor, further causes the at least one processor to:
receive a Radio Network Temporary Identity (RNTI), an effective duration of the semi-persistent scheduling, and a period of the semi-persistent scheduling corresponding to each of the plurality of groups of the configuration parameters of the plurality of groups of configuration parameters sent by the base station through a Radio Resource Control (RRC) signaling, or
receive the Radio Network Temporary Identity for semi-persistent scheduling sent by the base station through the Radio Resource Control signaling, and receive the identification information, the effective duration of the semi-persistent scheduling, and the period of the semi-persistent scheduling corresponding to each of the plurality of groups of the configuration parameters of the plurality of groups of configuration parameters sent by the base station through a Downlink Control Information (DCI) signaling.

13. The vehicle communication of claim 11, wherein the plurality of instructions, when executed by the at least one processor, further causes the at least one processor to:
when it is determined that any one of semi-persistent scheduling process needs to be activated, send a notification message to activate the any one of the semi-persistent scheduling process to the base station.

14. The vehicle communication of claim 11, wherein the plurality of instructions, when executed by the at least one processor, further causes the at least one processor to:
send the message feature after the current vehicle communication service is changed, and/or the message feature of the new vehicle communication service to the base station through a medium access control unit signaling or a Radio Resource Control signaling.

15. The vehicle communication of claim 11, wherein, the message feature comprises at least one or a combination of:
a message period, a message size, a transmission time offset, a priority of a vehicle communication service, a modulation coding method adopted by the vehicle communication messages.

16-18. (canceled)

19. The vehicle communication of claim 13, wherein determining if the any one of semi-persistent scheduling process needs to be activated comprises:
select a semi-persistent scheduling process to be the semi-persistent scheduling process needs to be activated, a semi-persistent scheduling period being the same as the message period after the current vehicle communication service changed and/or a message period of the new vehicle communication service, a time-frequency resource size allocated by the semi-persistent scheduling being adapted to a message size after the current vehicle communication service is changed and/or a size of the message of the new vehicle communication service, an activation time of the semi-persistent scheduling being consistent with a transmission time offset of the current vehicle communication service and/or the transmission time offset of the new vehicle communication service.

20. The resource scheduling device for vehicle communication of claim 13, wherein when determining that a plurality of vehicle communication services need to adopt a same semi-persistent scheduling process according to the changed message feature and/or the message feature of the new vehicle communication service, preferentially schedule a highest priority vehicle communication service among the plurality of vehicle communication services based on the same semi-persistent scheduling process, after notifying the terminal to activate the same semi-persistent scheduling process.

21-22. (canceled)

23. The resource scheduling method for vehicle communication of claim 2, wherein when receiving the plurality of groups of configuration parameters for semi-persistent scheduling allocated by the base station through the Radio Resource Control (RRC) signaling, the time-frequency resource corresponding to the semi-persistent scheduling process can be demodulated based on the RNTI; when receiving the plurality of groups of configuration parameters for semi-persistent scheduling allocated by the base station through the DCI signaling, the time-frequency resources corresponding to the semi-persistent scheduling process can be demodulated based on the identifier information in the RNTI signaling and the DCI signaling.

24. The resource scheduling method for vehicle communication of claim 5, the transmission time offset is used to determine a time point when the vehicle communication message is sent in the next cycle, and the transmission time offset is represented by a sub-frame number.

25. The resource scheduling method for vehicle communication of claim 7, wherein when receiving the plurality of groups of configuration parameters for semi-persistent scheduling allocated by the base station through the Radio Resource Control (RRC) signaling, the time-frequency resource corresponding to the semi-persistent scheduling process can be demodulated based on the RNTI; when receiving the plurality of groups of configuration parameters for semi-persistent scheduling allocated by the base station through the DCI signaling, the time-frequency resources corresponding to the semi-persistent scheduling process can be demodulated based on the identifier information in the RNTI signaling and the DCI signaling.
